(19) United States
(12) Patent Application Publication
(10) Pub. No.: US 2012/0175188 A1
(43) Pub. Date: Jul. 12, 2012

(54) Multi - Function Ladder Attachment

(76) Inventor: Changliang Xu, Pittsburgh, PA (US)

(21) Appl. No.: 13/004,948

(22) Filed: Jan. 12, 2011

(51) Int. Cl. E06C 7/00; E06C 7/50; E06C 7/18

(52) U.S. Cl. 182/107

(57) ABSTRACT

An multi-function attachment for straight and extension ladder for enabling a ladder to stand upright upon an uneven or inclined surface, boosting ladder's stability on cable and wire rope, keeping ladder away from gutter, keeping ladder at roof peak, and providing a support for a work table or sawhorse. The attachment comprise one special device clamped over one rung and stile of the ladder, an extension with shoe that has slip-resistant rubber pad bottom can be vertically adjustable in the device or can be bolted onto device horizontally.

### BACKGROUND OF THE INVENTION

Several types of ladder accessories have been shown in various art patents to permit ladders to function as a ladder standoff, ladder leg extension, or roof ridge hook. Such as the following: U.S. Pat. No. 4,412,599. U.S. Pat. No. 4,184,569. U.S. Pat. No. 4,143,742. U.S. Pat. No. 3,027,968. U.S. Pat. No. 4,159,045. U.S. Pat. No. 2,360,640. U.S. Pat. No. 4,209,078. U.S. Pat. No. 3,937,298. U.S. Pat. No. 2,599,117.

All of above patents have various drawbacks. When you attach them to ladder, some are needed to alter the ladder, damage or weak the ladder, some are needed special tools, some are taken lot of time for assembling, and some are complex and are not easy to use.

The present invention relates to ladder accessories that have multi-functions for enabling a ladder to stand upright upon an uneven or inclined surface, boosting ladder's stability on cable and wire rope, keeping ladder away from gutter and keeping ladder at roof peak.

### BRIEF SUMMARY OF THE INVENTION

Present invention resides in a device attachable to the rung and stile of a ladder without alteration of the ladder or use of any tools to extent a ladder leg that is too short to reach the uneven supporting surface. Or offset ladder from gutter to prevent damages of gutter. Or use as roof ridge hook to keep ladder on roof peak. Or use as cable or wire rope hook.

It is a principal object of the present invention to provide a multi-function ladder attachment that can be very easy to switch between each function without modify of the ladder.

Another object of the present invention is the provision of a relatively simple and a reliable ladder attachment which is fast and easy to attach the device onto ladder securely by tighten only one secure bolt or detach it from ladder by loosing only one secure bolt.

A further object of the present invention is universal for left and right side of ladder stile.

### BRIEF DESCRIPTION OF THE SEVERAL VIEWS OF THE DRAWING

FIG. 1 is a perspective view showing my invention assembled.

FIG. 2 is a perspective explored view showing my invention parts.

FIG. 3 is a perspective view showing my invention assembled.

FIG. 4 is a perspective explored view showing my invention parts.

FIG. 5 is a 2D view showing my invention for multi-function use.

FIG. 6 is a perspective view showing my invention for multi-function use.

FIG. 7 is a perspective view showing my invention is used as roof ridge hook.

FIG. 8 is a perspective view showing my invention is used at building corner

FIG. 9 is a perspective view showing my invention is used as cable/wire hook.

FIG. 10 is a perspective view showing my invention is used as stand off.

FIG. 11 is a perspective view showing my invention is used as leveler.

FIG. 12 is a perspective detail view showing my invention attached to the side stile of a ladder as roof support and roof ridge hook.

FIG. 13 is a perspective detail view showing my invention attached to the side stile of a ladder as leveler.

FIG. 14 is a perspective detail view showing my invention attached to the side stile of a ladder as cable/wire hook.

FIG. 15 is a front view of metal rectangular housing 6.

FIG. 16 is a back view of metal rectangular housing 6.

FIG. 17 is a top view of metal rectangular housing 6.

FIG. 18 is a side view of metal rectangular housing 6.

FIG. 19 is a perspective view of metal rectangular housing 6.

FIG. 20 is a perspective view of metal rectangular housing 6.

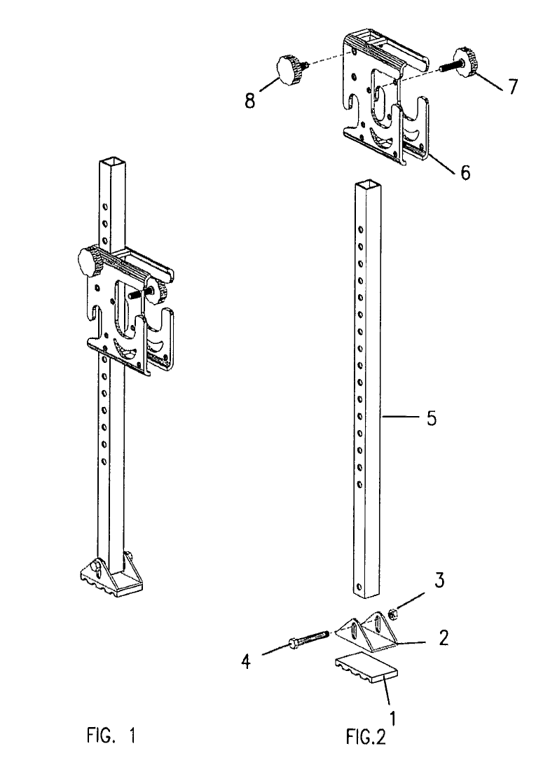

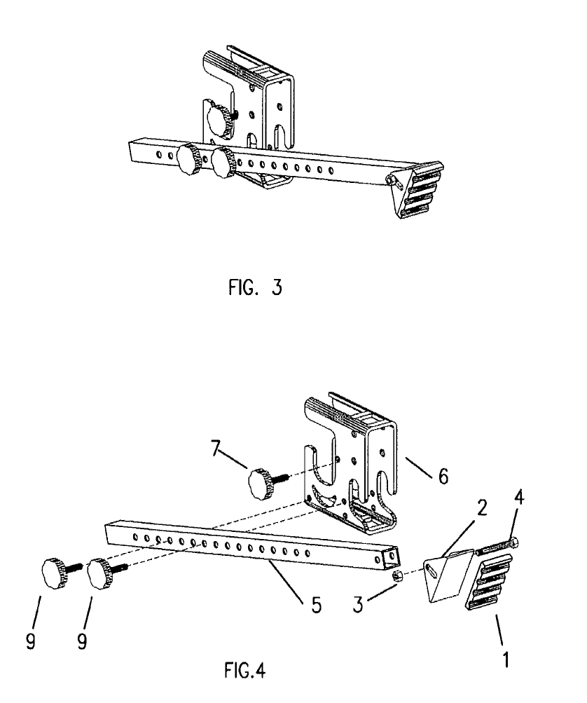

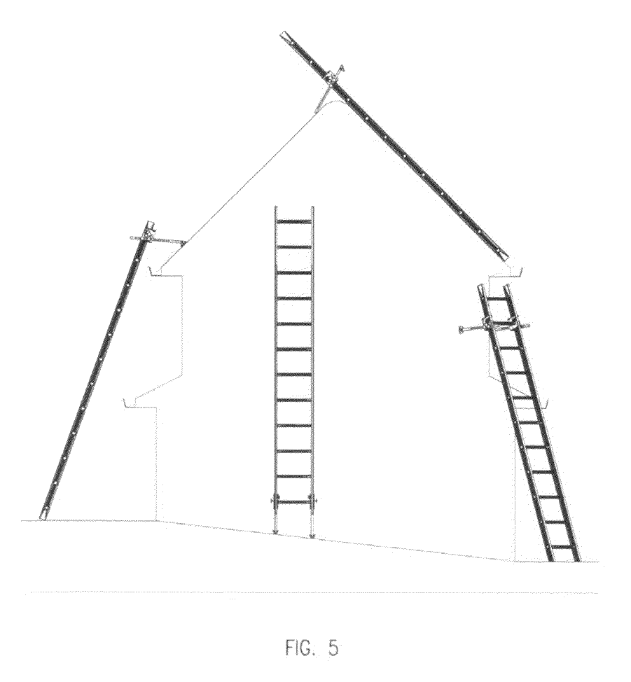

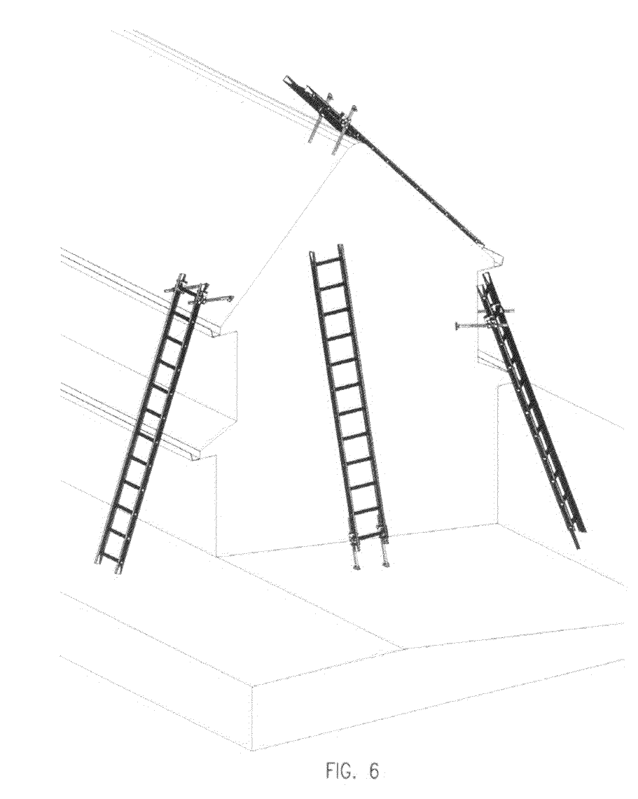

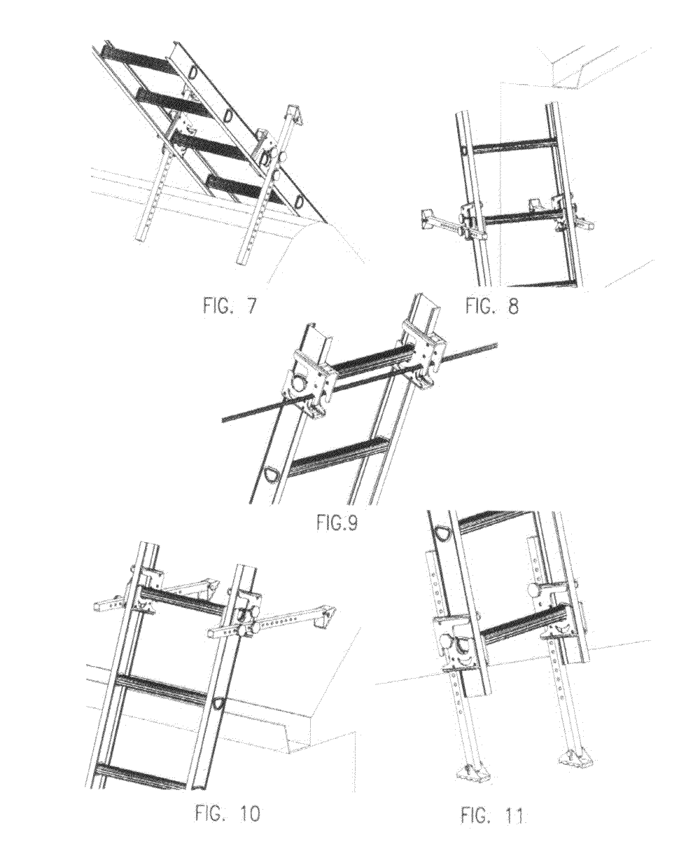

### DESCRIPTION OF THE PREFERRED EMBODIMENT

A detailed description of present invention now follows in conjunction with the appended drawing.

Referring to FIG. 2 and FIG. 4

The multi-function ladder attachment of my invention comprises, in general, a metal rectangular housing 6 that has different cutouts and threaded holes, a square metal tubular extension 5 that has series of holes for length adjustment, a swing leg shoe 2 that has slip-resistant rubber pad 1, a bolt 4 with self-lock nut 3, a secure bolt 7, a adjusting lock bolt 8 and two fasten bolts 9.

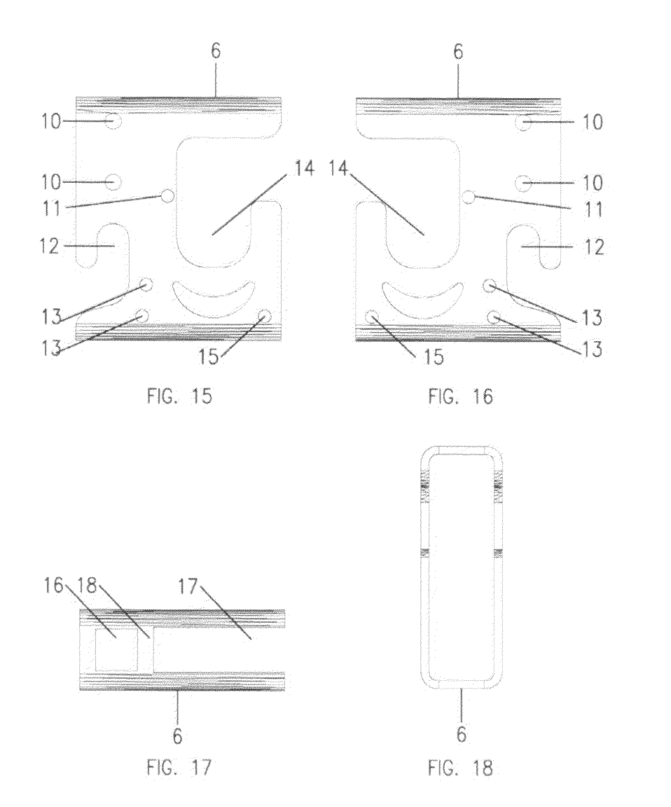

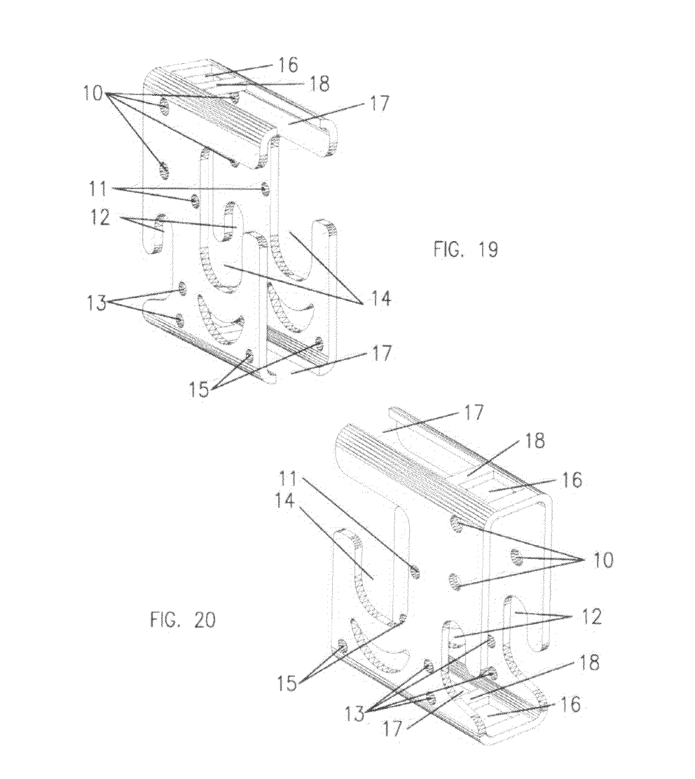

Referring to FIG. 15 to FIG. 20

The key component of my multi-function ladder attachment invention is a metal rectangular housing 6 that has same cutouts 12, 14 and threaded holes 10, 11, 13, 15 on both side walls, and same cutout 16, 17 on top and bottom wall. Cutout 12 functions as hook to receive cable/wire, cutout 14 having supporting and securing means for adapting ladder rung 21, two threaded holes 10 to receive adjusting lock bolt 8 and they are 1.5 time distance apart of adjustable holes on extension 5 to ensure more fine length adjustment (for example, if the holes on extension 5 is ¾″ apart, then we can get ⅜″ adjustment when we put lock bolt 8 in different threaded hole 10), threaded hole 11 to receive secure bolt 7 that securing metal rectangular housing 6 onto ladder stile 19, two threaded holes 13 has same distance to threaded hole 15 and the distance is multi distance of holes on extension 5, threaded holes 13 and 15 to receive fasten bolt 9 that securing extension 5 onto metal rectangular housing 6, cutout 16 to adapt extension 5, cutout 17 to receive ladder stile 19, the bridge 18 between cutout 16 and 17 has supporting/spacing and securing means to keep extension 5 away from ladder stile 19 and keep metal rectangular housing 6 from tilting/turning around ladder rung/stile.

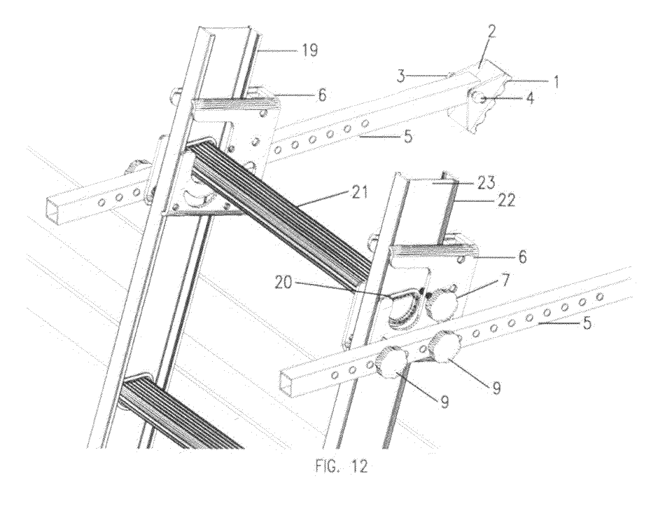

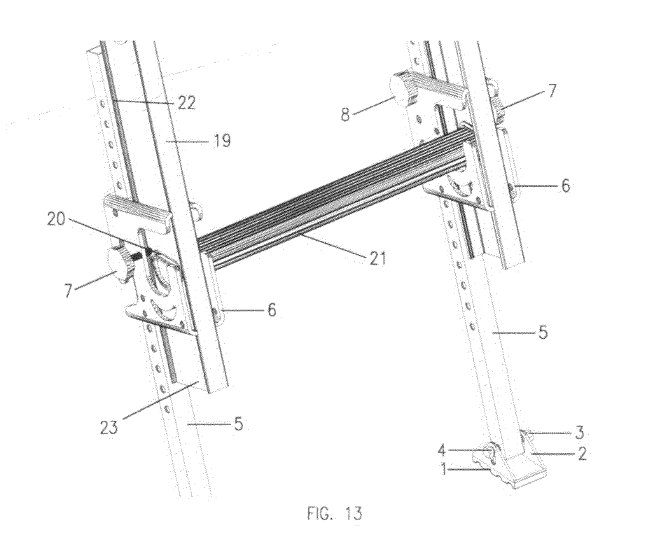

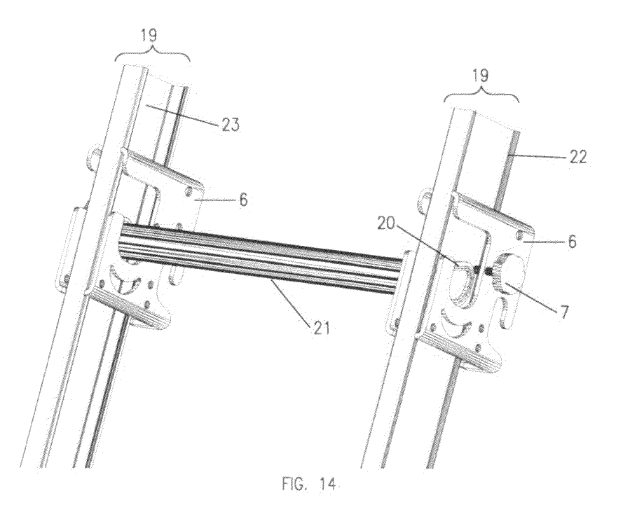

Referring to FIG. 12 to FIG. 14

The present invention is the provision of a relatively simple and a reliable ladder attachment which is fast and easy to attach the device onto ladder securely by tighten only one secure bolt 7 or detach it from ladder by loosing only one secure bolt 7. When use this ladder attachment as leveler, insert extension 5 into cutout 16 and secure it in place by turning lock bolt 8 into one of series hole on extension 5, slide metal rectangular housing 6 over ladder stile 19 and rung 21 until ladder stile 19 into cutout 17 and ladder rung 21 touching bottom of one cutout 14, tighten secure bolt 7 until it reaches the center wall 23 of ladder stile and sits on top of rung flange 20. The secure bolt 7 works with cutout 14, cutout 17, bridge 18, ladder rung 21, ladder stile side wall 22 and flange 20 to perform multi supporting and securing means, when secure bolt 7 works with cutout 14 and flange 20, it keeps metal rectangular housing 6 from moving up down, the ladder stile side wall 22 is between the secure bolt 7 and bridge 18 and cutout 14, 17 that preventing metal rectangular housing 6 from turning around ladder stile 19, also preventing metal rectangular housing 6 from turning around ladder rung 21.

When use this ladder attachment as standoff, or roof ridge hook, or work table support, or saw horse, attach extension 5 onto side wall of metal rectangular housing 6 by screw two fasten bolts 9 through series hole on extension 5 and into holes 13, 15. Use different hole 13 can get different angle that extension 5 related to ladder stile 19 When use this ladder attachment as cable/wire hook, only need to use metal rectangular housing 6 and secure bolt 7.

The metal rectangular housing 6 can be made of a metal rectangular tubular or can be formed by welding four pieces of metal plates or two 90 degree metal angles together.

The ornamental design for a multi-function ladder attachment is as shown and described. The present invention provides a number of important advantages. The multi-function ladder attachment is of relatively simple construction, is fast and easily attached to the rung and stile of a ladder in a desired operative position, and is safe and reliable in operation.

It will be understood that modification can be made in the embodiment of the invention illustrated and described herein without departing from the scope and purview of the invention as defined by the appended claims.

What I claim as new and desire to protect by Letters Patent of United States is:

1. A multi-function ladder attachment that secure attach onto the rung and stile of straight and extension ladder, in combination, a special design metal rectangular housing having two square cutouts on top and bottom to adapt the adjustable metal tubular extension; two rectangular cutouts on top and bottom to receive ladder stile and prevent ladder attachment from turning around ladder stile; one big cutout on both side walls to support and secure ladder rung in position, it also prevents ladder attachment from moving up, forwarding or back warding, also it works together with two rectangular cutouts on top and bottom to keep ladder attachment from turning around ladder rung; one threaded hole to receive secure bolt on both side walls having further secure means to keep ladder attachment in position; two threaded holes to receive adjusting lock bolt on both side walls are 1.5 time distance apart of series holes on adjustable metal tubular extension to ensure fine length adjustment; three threaded holes to receive fasten bolts that go through the holes of the adjustable metal tubular extension and secure extension onto metal rectangular housing, the angle between the extension and ladder stile can be changed when use different hole. One small cutout on both side walls of metal rectangular housing functions as hook to receive cable/wire. There are same cutouts and threaded holes on both side walls, and same cutouts on top and bottom of metal rectangular housing, that makes this attachment universal for left and right side of ladder stile.

2. A multi-function ladder attachment as claimed in claim 1 wherein the one threaded hole to receive secure bolt on both side walls of metal rectangular housing has special location that sits between top of ladder rung flange and inside surface of sidewall of ladder stile. This location made it possible to use only one secure bolt to clamp multi-function attachment onto ladder securely and easily.

3. A multi-function ladder attachment as claimed in claim 1, 2 wherein the secure bolt that tighten against center wall of ladder stile and sits between top of ladder rung flange and inside surface of sidewall of ladder stile performs multi secure task; secure bolt pulls the long side of rectangular cutout on metal rectangular housing tightly against ladder stile and prevents metal rectangular housing from turning around ladder stile; secure bolt sits on top of ladder rung flange and keeps metal rectangular housing from sliding down along ladder stile; secure bolt sits on inside surface of sidewall of ladder stile will secure the sidewall of ladder stile between secure bolt and short side of rectangular cutout on top and bottom of metal rectangular housing and prevents metal rectangular housing from moving forward or backward, also prevents metal rectangular housing from turning around ladder stile and rung.
